(19) United States
(12) Patent Application Publication
(10) Pub. No.: US 2005/0061193 A1
(43) Pub. Date: Mar. 24, 2005

(54) Device for conveying nested packings

(76) Inventors: Juergen Rothbauer, Michelfeld (DE); Bernd Laukenmann, Onolzheim (DE)

Correspondence Address: QUARLES & BRADY LLP, 411 E. WISCONSIN AVENUE, SUITE 2040, MILWAUKEE, WI, 53202-4497, US

(21) Appl. No.: 10/945,122

(22) Filed: Sep. 20, 2004

(30) Foreign Application Priority Data
Sep. 21, 2003 (DE) 10345339.3

(51) Int. Cl. B65G 37/02; B65G 47/52

(52) U.S. Cl. 104/96; 198/346.1; 198/586

(57) ABSTRACT

A conveyor system for conveying nested packings in a filling plant operates with two independently controlled trolleys, which respectively have a centering plate for receiving a nest. Whilst the packings are being treated on the first trolley, the second trolley takes over the ready-treated nest, brings it to the delivery point and travels back again empty. Dead times resulting from empty runs, or additional centering motions in the handling of the packings, are thereby prevented.

The invention relates to a device for conveying nested packings in a filling bay.

By nested packings are understood packings which are disposed in a nest or magazine for further handling. Further handling generally comprises filling and following sealing. Preferably this concerns disposable syringes, which are supplied nested and sterile-packed in a box for further handling.

In a known nest conveyor with slide system, the nest, for example in the tight packing provided for the conveyance, is placed in a centering plate mounted on a slide. The centering plate can be designed such that every single syringe from the nest is individually centered. The nest is taken over from the slide at the loading position and conveyed to the filling and sealing handling bay. Following treatment, the nest is conveyed with the slide to the unloading position. After the nest with the sealed packings has been removed from the slide, this returns empty to the loading position in order to receive a new nest. It travels back by the same route. The slide is driven by two controlled axles. The first axle serves the conveyance in the direction of conveyance, whilst the second, transversely running axle is intended to correct the stagger of the rows of packings. The packings are arranged such that the respectively following row is staggered by half a packing spacing relative to the preceding row. In this way, packing density can be increased.

By virtue of the centering plate, all syringes are precisely fixed during conveyance and can thus be directly handled without any further effort. The conveyor slide can be individually controlled in terms of its cycle at any chosen location.

During the unloading of the slide, the return travel of the empty slide and its reloading, the device is unable, however, to fill and seal, so that the device has a limited output.

A conveyor system is also proposed in which the nest is placed in a conveyor which comprises belts and chains and has dogs. The conveyor system is divided by the dogs into even units, which can respectively receive a nest. In this conveyor system, a row of syringes must in each case be released at the treatment bays in the nest in order to allow centering. This is realized by additional motions, namely the raising of the syringes and their centering by means of grabs. As a result of this continuous conveyor system, it is possible to convey nest upon nest, so that no dead times arise in which the conveyor makes an empty run.

The centering of the individual rows of syringes leads to a reduction in machine output due to increased conveying time. As a result of the mechanisms required for the centering and lifting, it is not possible in this case to seal the syringes immediately after filling. This is a requirement, however, in pharmaceutics.

The object of the invention is to provide a device for conveying nested packings in a filling bay, which allows increased output, at the same time as meeting the pharmaceutical requirements.

For the achievement of this objective, the invention proposes a device having the features stated in claim 1. Refinements of the invention are the subject of subclaims.

The device according to the invention thus contains a rail medium, comprising two rail tracks. On the rails, two trolleys can be transported independently from each other. One trolley can contain the nest with the centering plate and at the filling bay can be moved forward in cycle, so that the packings contained therein and already centered in the centering plate are filled in cycle and immediately thereafter are sealed. Irrespective of the position of this trolley, the second trolley can take the sealed packings to a removal point, where they are removed from the truck. The empty trolley can be brought back into a position where it is filled with a new nest. The conveyance of the second trolley, i.e. of that trolley which specifically does not provide for the filling operations at the filling bay, is completely independent from the conveyance of the first trolley. In an empty run, nor is there need for cycling, so that the drive can be made simpler in design. The empty run can also proceed at a slower speed or, indeed, at a faster speed, completely independently from the cycled conveyance of the first trolley in the filling bay.

In order to switch the trolley from the first rail track, running past the filling bay, into the second rail track, a switching mechanism can be present at both ends. This can likewise operate completely independently from the drives of the two trolleys.

For example, the transfer mechanism at each end of the rail medium can in each case have a rail section which can be moved out of alignment with the one rail track into alignment with the other rail track. The length of the rail section here roughly corresponds to the length of the trolley, but may also be somewhat larger. At the end of this rail track, the trolley is therefore pushed onto the rail section disposed in extension of the rail track, whereupon this rail section is then displaced to the point where it is aligned with the other rail track. From there, the trolley can then be displaced along the second rail track. After this, the rail section is then pushed back again.

The two trolleys, excluding the connection to their drive, are identically configured, thereby maintaining the orientation of the trolley and that of its receiving fixture for the nest.

Preferably, the rail tracks can run parallel to each other.

The transfer mechanism can advantageously be configured such that it transfers the trolleys only in one direction, thus, for example, at the one end of the rail track leading past the filling bay transfers the trolley only to the return rail track, but not in the reverse direction. For the device will normally run through only in one direction of the trolley.

The two drives for respectively driving a trolley can advantageously operate independently from one another and separately. For example, both drive means can be displaceable along a dedicated rail, so that the trucks are able to move past each other.

It can especially be envisaged that the drives are connected to the trolleys by a dog in such a way that the transfer from the one rail track to the other rail track is enabled. The dog can therefore join in this transfer motion whilst the drive in this segment is idle.

According to the invention, it can be envisaged that the two rail tracks are disposed one above the other. The spatial requirement of the plant, which is primarily determined by the base area of the plant, is not thereby enlarged.

It is likewise possible and within the scope of the invention for the two rails tracks to be side by side, where this, in the individual case, is desirable for spatial or other reasons.

The filling bay is advantageously disposed above the upper rail track if the rail tracks are disposed one above the other.

Where the two rail tracks are disposed one above the other, the motion can then be particularly favorably started if, according to a further feature of the invention, the dogs are disposed on opposite sides of the rail tracks.

According to the invention, the delivery point at which the sealed packings are removed can be disposed at that end of the rail track lying opposite the feed point. It can be formed both on the one and on the other rail track. It is, however, also possible and is permitted by the invention for the delivery point to be roughly at the same place where the feed point, too, is disposed.

Further features, details and advantages of the invention derive from the following description of a preferred embodiment, the patent claims and the abstract, the both of whose wording is formulated by reference to the content of the description, and with reference to the drawing, in which:

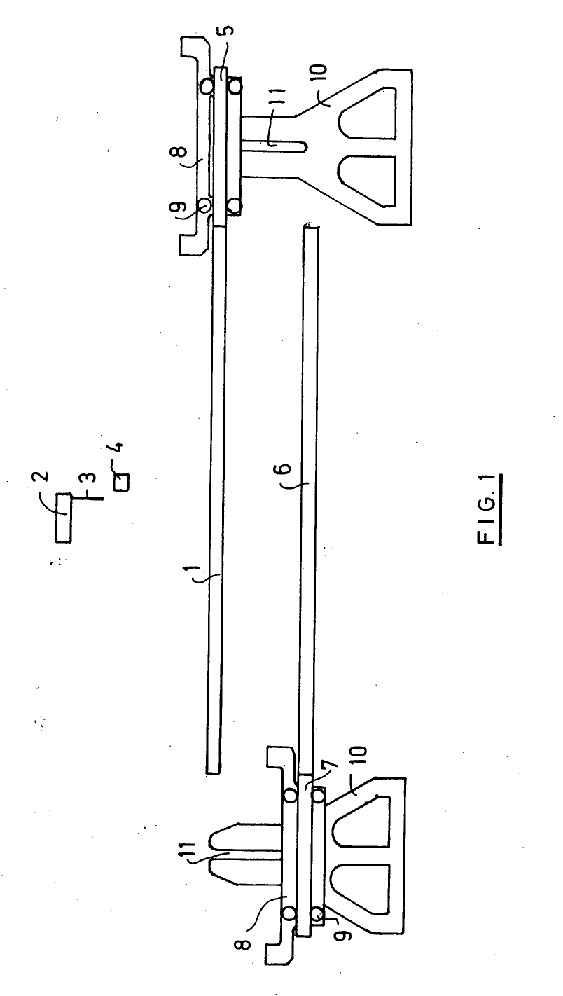

FIG. 1 shows diagrammatically a side view of the conveying operations in the plant;

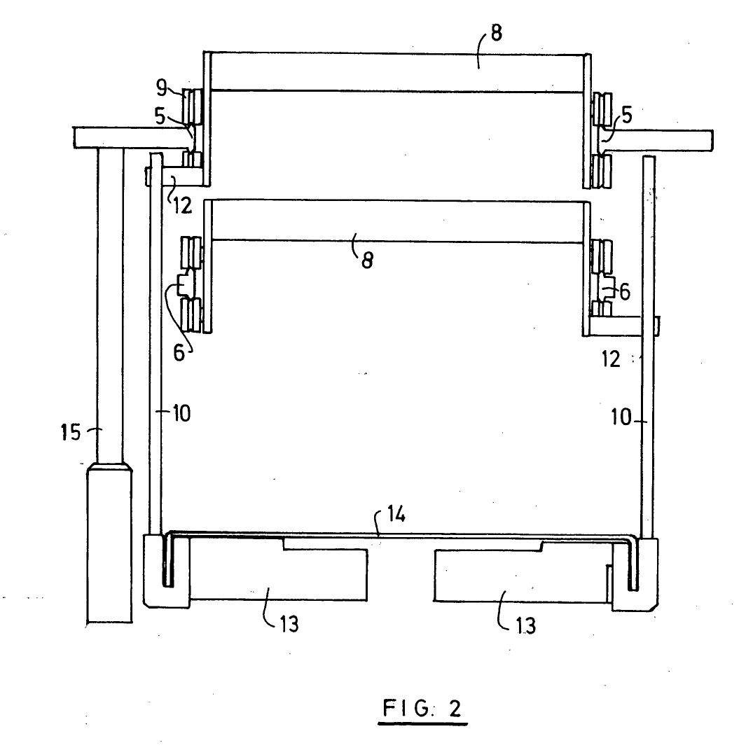

FIG. 2 shows a front view of the conveyor device represented in FIG. 1.

FIG. 1 shows in heavily diagrammatized representation the way in which a nest of packings can be conveyed in a plant for filling the packings. A first rail track 1 is present, which runs horizontally. It may comprise, for example, two rails, arranged in the manner standard to rail pairs. A single rail could also, however, be present. The rail track 1 leads past beneath a filling bay 2 having individual filling needles 3 and a sealing bay 4. Since the packings are first filled and are then sealed, the arrangement of filling bay 2 and sealing bay 4 indicates the direction of conveyance, which in FIG. 1 shows from left to right. At the end of the rail track 1, an individual rail section 5, aligned in its extension, is present, which constitutes a continuation of the rail track 1.

Beneath the rail track 1 a second rail track 6 is present, which likewise runs horizontally. It has roughly the same length and the same arrangement as the first rail track 1 and is identically constructed in its functioning. In the representation of FIG. 1, at the opposite end, a rail section 7 is likewise disposed in extension of the rail track 6 and aligned relative to the latter.

On the two rail tracks 1, 6, two trolleys 8 are displaceably run, both of which trolleys 8, in the representation of FIG. 1, are positioned specifically on the individual rail sections 5 and 7. The two trolleys 8 can be displaced along the rail tracks 1 and 6. They are respectively displaceable by means of two roller pairs 9, so that they can be easily displaced with low rolling resistance and without jolts.

Each rail section 5, 7 can be moved by a displacement mechanism (not represented) out of alignment with the respective one rail track 1 and 6 into alignment and extension with the respective other rail track 6, 1. It is thereby possible to switch a trolley 8 from the one rail track to the other rail track. The two displacement mechanisms for the rail sections 5, 7 operate independently of each other. The two rail sections 5, 7 can thus be disposed, for example, in alignment with the upper rail track 1 or, indeed, with the lower rail track 6, and both trolleys 8 may also at a certain moment be disposed on the same rail track 1 or 6.

For each trolley 8, there is a dedicated drive assigned specifically to this trolley 8. The drive contains a drive carriage 10, which in FIG. 1 can be displaced from left to right and back. The drive carriage 10 contains a vertically running slot 11, which can be open or, indeed, closed-at the top. Into this slot engages a dog (not visible in FIG. 1) of the trolley 8. The length of the slot 11 is dimensioned such that this dog is engaged with the slot 11 in every position of the rail section 5, 7. If the rail section 5 or 7 is in its lower position, see on the left in FIG. 1, the dog, at the lower end of the slot 11, engages in the latter. When the rail section 5, 7 is in the upper position, see on the right in FIG. 1, the dog is still contained in the slot 11. The trolleys 8 are thus connected to the drive carriage 10 only in the direction of conveyance of the rail tracks 1, 6, yet not in a direction perpendicular to the direction of conveyance of the rail tracks 1, 6.

Now to FIG. 2. FIG. 2 shows a type of front view and a section through the arrangement of FIG. 1 roughly along the line II-II. The upper trolley 8 is disposed with the roller pair 9 on the rail section 5 disposed in extension of the upper rail track 1. On that side of the trolley 8 on the left in FIG. 2, the aforementioned dog 12 reaches through the slot 11 in the drive carriage 10. On the opposite side, there is no such dog 12. Here the trolley 8 is conducted only by the roller pair 9 on the rail section 5.

The lower end of the drive carriage 10 is connected to an enclosed drive 13 displaceable perpendicular to the paper plane. The motion of the drive carriage 10 perpendicular to the paper plane, which is produced by the drive 13, takes with it the trolley 8, owing to the engagement of the dog 12.

The second trolley 8 conducted on the lower rail track 6 by the roller pair 9 has on the opposite side, thus on the right in FIG. 2, the dog 12, which reaches through the corresponding slot 11 in the drive carriage 10. This drive carriage 10 has a dedicated, similarly constructed drive 13, which is fitted enclosed beneath a bottom plate 14. The two drives 13 operate independently from each other, so that the two trolleys can also be moved independently from each other.

Both rail sections 5, 7 have a drive which forms a displacement mechanism and in FIG. 2 is shown as a hydraulic piston 15. It is intended to indicate purely diagrammatically the possibility of how a rail section 5, 7 can be brought out of alignment with the upper rail track 1 into alignment with the lower rail track 6.

As can likewise be gathered from FIG. 2, a certain distance is present between the two trolleys 8. Both trolleys serve to receive a nest with packings. The two trolleys 8 can be moved past each other, since the two drives 13 likewise do not disturb each other in their motion.

Back to FIG. 1. The modus operandi of the device can proceed as follows. The trolley 8 on the left in FIG. 1 is pushed upward by actuation of the drive of the displacement mechanism for the rail section 7, until the rail section 7 is aligned relative to the rail track 1. This can be, for example, the feed position, in which a nest with packings to be filled is placed. The trolley 8 can contain the centering plate mentioned in the introduction. Following the insertion of the packing into the centering plate, the centering is effected and then the trolley 8 is moved off as far as the filling bay, controlled by means of a control system and a servomotor. As soon as the first row of the nest of packings has reached the filling bay 2, the trolley 8 is moved on cyclically by respectively one row spacing, and the individual packings are filled by the filling bay 2 and then sealed by the sealing bay 4. As soon as all the packings of the nest are filled and sealed, the trolley 8 can now be moved continuously fully to the right, until it occupies the position represented on the right in FIG. 1. In this position, the filled and sealed nest is able to be removed. Next the trolley is pushed downward and continuously pushed back over the lower rail track 6, until it has made its way back into the feed position. Whilst it is being moved back, the second trolley can be provided with a nest of empty packings and filled at the filling bay 2. The role of the two trolleys 8 is constantly alternating, whereby a continuous chain for the filling is formed.

Since the adjacent rows in the centering plate are staggered by half a packing spacing, a transverse motion takes place either of the trolley on the rail track 1, or of the centering plate on the trolley, or of the rail track 1. This is not represented in detail, since it corresponds to the prior art.

1. A device for conveying nested packings in a filling bay, comprising a rail medium which forms a direction of conveyance, the rail medium having a first rail track leading from a feed point past a filling bay and a second, return rail track, two trolleys bearing displaceable independently from each other on the two rail tracks, for respectively at least one nest of packings further comprising a respective drive for each trolley, and having a respective transfer mechanism at both ends of the rail medium for transferring a trolley from one rail track to the other.

2. The device as claimed in claim 1, wherein the two rail tracks run parallel to each other.

3. The device as claimed in claim 1, wherein the transfer mechanism operates respectively only in one direction.

4. The device as claimed in claim 1, wherein the two drives for the two trolleys operate separately from each other.

5. The device as claimed in claim 1, wherein the two drives for the trolleys are displaceable along a dedicated rail.

6. The device as claimed in claim 1, wherein the drives are connected to the trolleys by a respective dog in such a way that the transfer motion from one rail track to the other rail track is enabled.

7. The device as claimed in claim 1, wherein the two rail tracks are disposed one above the other.

8. The device as claimed in claim 1, wherein the filling bay and/or the sealing bay is disposed above the upper rail track.

9. The device as claimed in claim 6, wherein the dogs are disposed on opposite sides of the rail tracks.

10. The device as claimed in claim 1, wherein the two rail tracks are disposed side by side.

11. The device as claimed in claim 1, having a delivery point for the nests with filled and sealed packings at that end of the rail tracks lying opposite the feed point.

12. The device as claimed in claim 1, wherein the transfer mechanism has a rail section, the length of which roughly corresponds to the length of a trolley and which can be moved out of alignment with the one rail track into alignment with the respective other rail track.
